(19) United States
(12) Patent Application Publication
(10) Pub. No.: US 2016/0162681 A1
(43) Pub. Date: Jun. 9, 2016

(54) COMMUNICATION DEVICE AND QUICK SELECTION METHOD

(71) Applicant: FIH (HONG KONG) LIMITED, Kowloon (HK)

(72) Inventor: WANG-HUNG YEH, New Taipei (TW)

(21) Appl. No.: 14/694,835

(22) Filed: Apr. 23, 2015

(30) Foreign Application Priority Data
Dec. 3, 2014 (CN) 201410727697.2

(51) Int. Cl. G06F 21/44; G06F 3/0484; G06F 3/0488; G06F 3/041

(52) U.S. Cl. CPC G06F 21/44; G06F 3/041; G06F 3/04842; G06F 3/0488; G06F 2221/2129

(57) ABSTRACT

A quick selection method executable on a touch screen communication device for quickly initiating communication includes designating a predetermined quick selection action and a quick selection region of the touch screen, choose one or more quick contacts from a list of previously entered contacts to initiate quick communication with, and performing the predetermined quick selection action on the predetermined quick selection region of the touch screen.

### CROSS-REFERENCE TO RELATED APPLICATIONS

This application claims priority to Chinese Patent Application No. 201410727697.2 filed on Dec. 3, 2014, the contents of which are incorporated by reference herein.

### FIELD

The subject matter herein generally relates to communication technology, and particularly to a communication device and a quick selection method for quickly initiating communication.

### BACKGROUND

A communication device (e.g., a smart phone or a tablet computer) is used to communicate with others. When a user wants to make a phone call to a contact, the user has to open a contact list (e.g., a phone book) first, and then select the contact. It is inconvenient and inefficient for the user when a quick call or an emergency call is needed.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one embodiment of a communication device including a quick selection system.

FIG. 2 is a block diagram of one embodiment of function modules of the quick selection system in the communication device in FIG. 1.

FIG. 3 is a diagrammatic view of one embodiment of a quick selection region of the quick selection system in the communication device in FIG. 1.

FIG. 4 is a diagrammatic view of another embodiment of a quick selection region of the quick selection system in the communication device in FIG. 1.

FIG. 5 illustrates a flowchart of one embodiment of a method for quick selection with the communication device in FIG. 1.

FIG. 6 is a diagrammatic view of one embodiment of choosing a predetermined quick contact.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one”.

The term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series and the like.

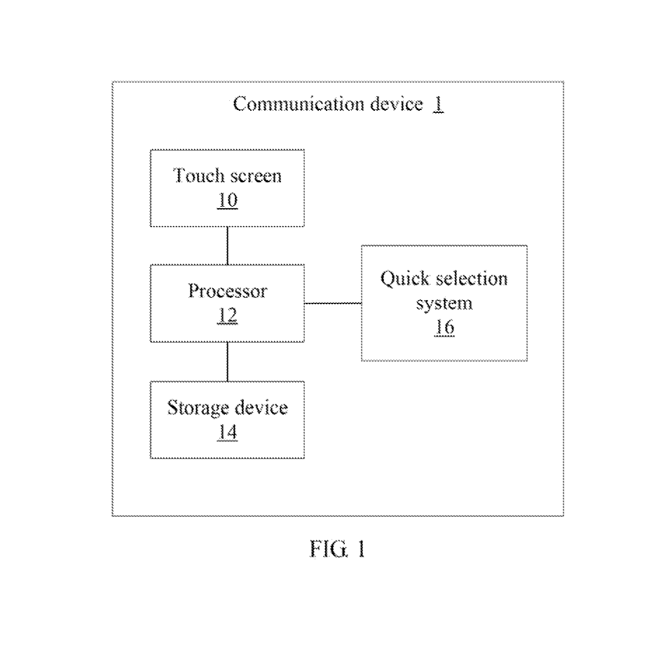

FIG. 1 illustrates a block diagram of one embodiment of a communication device. In at least one embodiment, as shown in FIG. 1, a communication device 1 includes, but is not limited to, a touch screen 10, at least one processor 12, a storage device 14, and a quick selection system 16. The communication device 1 can be a tablet computer, a smart phone, a personal digital assistant (PDA), or any other communication device. FIG. 1 illustrates only one example of the communication device 1 that can include more or fewer components than illustrated, or have a different configuration of the various components in other embodiments.

In at least one embodiment, the touch screen 10 can be touch panels, which support multi-touch, such as resistive touch screens or capacitive touch screens. The at least one processor 12 can be a central processing unit (CPU), a microprocessor, or other data processor chip that performs function of the quick selection system 16 in the communication device 1.

In at least one embodiment, the storage device 14 can include various types of non-transitory computer-readable storage medium. For example, the storage device 14 can be an internal storage system, such as a flash memory, a random access memory (RAM) for temporary storage of information, and/or a read-only memory (ROM) for permanent storage of information. The storage device 14 can also be an external storage system, such as an external storage device would be in communication with (or accessible by) the electronic communication device 1.

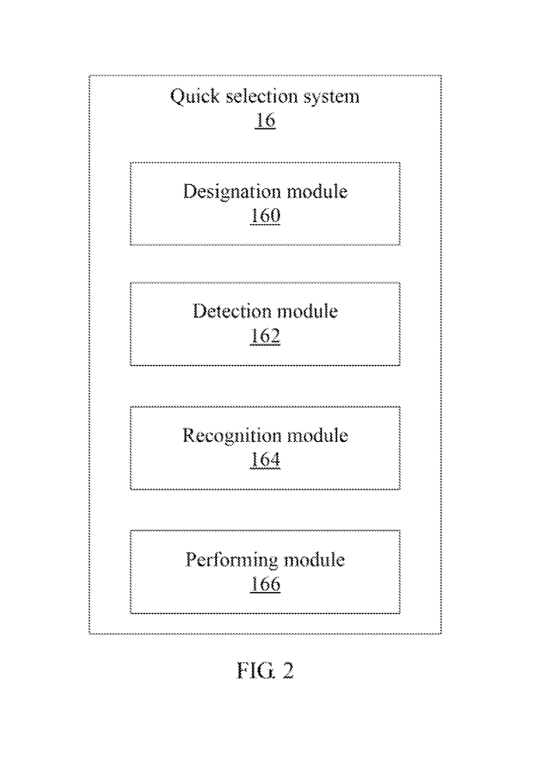

FIG. 2 is a block diagram of one embodiment of function modules of the quick selection system. In at least one embodiment, the quick selection system 16 can include a designation module 160, a detection module 162, a recognition module 164, and a performing module 166. The function modules 160, 162, 164 and 166 can include computerized codes in the form of one or more programs, which are stored in the storage device 14 of the communication device 1. The at least one processor 12 executes the computerized codes to provide functions of the function modules 160, 162, 164, and 166.

The designation module 160 designates a quick selection region and one or more quick contacts, and predetermines a quick selection action.

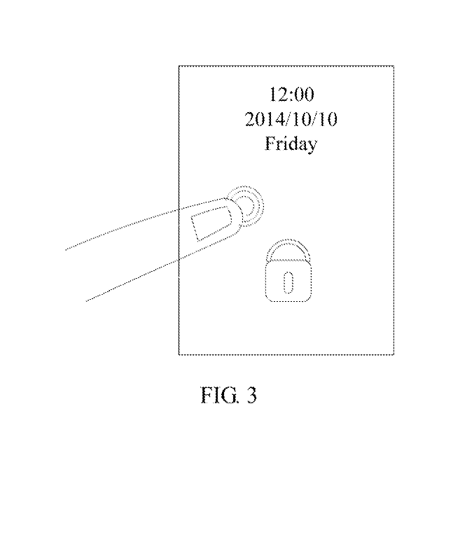

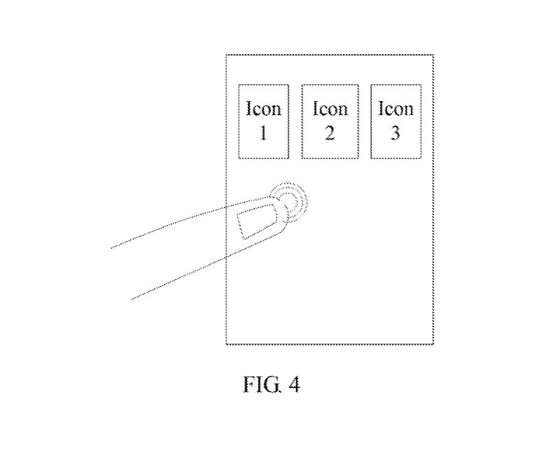

In at least one embodiment, the quick selection region is a region on the touch screen 10, for example, the quick selection region can be the full area of the touch screen 10 except for an unlocking area on the touch screen 10 when the touch screen 10 is locked, as shown in FIG. 3. In other embodiments, the quick selection region also can be any designated region on a user interface displayed on the touch screen 10 except for icons on the user interface, as shown in FIG. 4. Through the quick selection region, a user of the communication device 1 can make a phone call to one of the quick contacts conveniently.

In some embodiments, the one or more quick contacts are chose by the user from a list of previously entered contacts stored in the storage device 14 of the communication device.

In at least one embodiment, the quick selection action can be a tap on the quick selection region a predetermined number of times (e.g., three times) within a first predetermined time period (e.g., one second). If time actually taken for tapping the quick selection region three times exceeds the first predetermined time period, the quick selection action is deemed invalid.

In another embodiment, the quick selection action can be pressing the quick selection region throughout a second predetermined time period (e.g., five seconds).

The detection module 162 detects whether the quick selection action is triggered in the quick selection region. In at least one embodiment, the detection module 162 detects an action in the quick selection region, and displays the quick selection region.

The recognition module 164 determines whether the detected action in the quick selection region is in accordance with a quick selection action. If the detected action in the quick selection region is in accordance with a quick selection action, that is, the quick selection action is determined as being triggered in the quick selection region, then the performing module 166 performs the quick selection region to initiate the quick selection communication. If the detected action in the quick selection region is deemed not in accordance with a quick selection action, the performing module 166 does not performs any action.

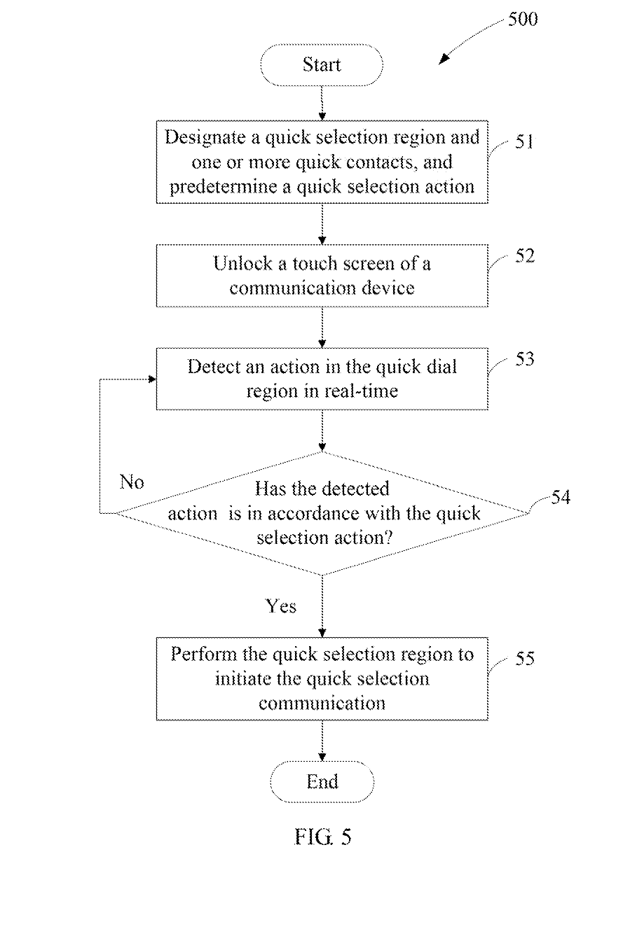

Referring to FIG. 5, a flowchart is presented in accordance with an example embodiment. An example method 500 is provided by way of example, as there are a variety of ways to carry out the method. The example method 500 described below can be carried out using the configurations illustrated in FIG. 1 and FIG. 2, for example, and various elements of these figures are referenced in explaining example method 500. Each block shown in FIG. 5 represents one or more processes, methods, or subroutines, carried out in the example method 500. Furthermore, the illustrated order of blocks is by example only and the order of the blocks can be changed. The example method 500 can begin at block 51. Depending on the embodiment, additional blocks can be added, others removed, and the ordering of the blocks can be changed.

At block 51, a designation module designates a quick selection region and one or more quick contacts, and predetermines a quick selection action.

At block 52, the touch screen 10 of the communication device 1 is unlocked. In some embodiments, the touch screen 10 is unlocked by pressing a physical button of the communication device 1, or pressing a virtual key for a third predetermined time period (e.g., three seconds).

At block 53, a detection module detects an action in the quick selection region as the action happens.

At block 54, a recognition module determines whether the detected action in the quick selection region is in accordance with a quick selection action. If the detected action in the quick selection region is in accordance with a quick selection action, the procedure goes to block 55. If the detected action in the quick selection region is not in accordance with a quick selection action, the procedure remains in block 53.

At block 55, a performing module performs the quick selection region to initiate the quick selection communication.

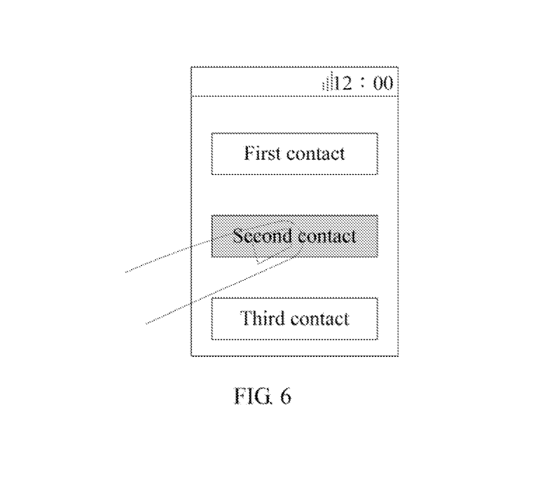

In some embodiments, the user of the communication device 1 can designate a single quick contact, thus when the quick selection action is selected in the quick selection region, the performing module performs the quick selection region to initiate the quick selection communication. In other embodiments, the user of the communication device 1 can designate more than one quick contact. When a quick selection action is selected in the quick selection region, all the contacts are displayed on the touch screen 10. Then, when a quick contact is selected, the performing module performs the predetermined quick selection action on the predetermined quick selection region of the touch screen. As shown in FIG. 6, the user of the communication device 1 has designated three contacts, a first contact, a second contact, and a third contact. When a quick selection action is selected in the quick selection region (e.g., tapping the quick selection region three times within one second), the three contacts are displayed on the touch screen 10, and the performing module makes a phone call after the user has select the second contact shown in FIG. 6.

To prevent accidental touches, the detection module detects an action in the quick selection region in real-time after the touch screen 10 of the communication device 1 is unlocked.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A quick selection method executable on a touch screen communication device for quickly initiating communication, the method comprising:
choosing one or more quick contacts to initiate quick communication with;
designating a quick selection region of the touch screen;
designating a predetermined quick selection action; and
performing the predetermined quick selection action on the predetermined quick selection region of the touch screen.

2. The method according to claim 1, wherein the predetermined quick selection action is detected after the communication device is woke up from a sleep mode.

3. The method according to claim 1, wherein the quick selection region is a region on the touch screen except for an unlocking area on the touch screen when the touch screen of the communication device is locked, or a region on a user interface displayed on the touch screen except for icons on the user interface.

4. The method according to claim 1, wherein the one or more quick contacts are chose from a list of previously entered contacts stored in a storage device of the communication device.

5. The method according to claim 1, wherein the predetermined quick selection action is taping the quick selection region for predetermined times within a first predetermined time period, or pressing the quick selection region throughout a second predetermined time period.

6. A communication device, comprising:
a touch screen;
at least one processor; and
a storage device that stores one or more programs which, when executed by the at least one processor, cause the at least one processor to:
choose one or more quick contacts to initiate quick communication with;
designate a quick selection region of the touch screen;
designate a predetermined quick selection action; and
perform the predetermined quick selection action on the predetermined quick selection region of the touch screen.

7. The communication device according to claim 6, wherein the predetermined quick selection action is detected after the communication device is woke up from a sleep mode.

8. The communication device according to claim 6, wherein the quick selection region is a region on the touch screen except for an unlocking area on the touch screen when the touch screen of the communication device is locked, or a region on a user interface displayed on the touch screen except for icons on the user interface.

9. The communication device according to claim 6, wherein the one or more quick contacts are chose from a list of previously entered contacts stored in a storage device of the communication device.

10. The communication device according to claim 6, wherein the predetermined quick selection action is taping the quick selection region for predetermined times within a first predetermined time period, or pressing the quick selection region throughout a second predetermined time period.

11. A non-transitory storage medium having stored thereon instructions that, when executed by at least one processor of a communication device, causes the at least one processor to perform a method for quick selection, the communication device comprising a touch screen, wherein the method comprises:
choosing one or more quick contacts to initiate quick communication with;
designating a quick selection region of the touch screen;
designating a predetermined quick selection action; and
performing the predetermined quick selection action on the predetermined quick selection region of the touch screen.

12. The non-transitory storage medium according to claim 11, wherein the predetermined quick selection action is detected after the communication device is woke up from a sleep mode.

13. The non-transitory storage medium according to claim 11, wherein the quick selection region is a region on the touch screen except for an unlocking area on the touch screen when the touch screen of the communication device is locked, or a region on a user interface displayed on the touch screen except for icons on the user interface.

14. The non-transitory storage medium according to claim 11, wherein the one or more quick contacts are chose from a list of previously entered contacts stored in a storage device of the communication device.

15. The non-transitory storage medium according to claim 11, wherein the predetermined quick selection action is taping the quick selection region for predetermined times within a first predetermined time period, or pressing the quick selection region throughout a second predetermined time period.
